(19) United States
(12) Patent Application Publication
(10) Pub. No.: US 2019/0164146 A1
(43) Pub. Date: May 30, 2019

(54) SCANNABLE AND ACTUATABLE DISPLAY PORTION FOR PAYMENT APPLICATIONS

(71) Applicant: MasterCard International Incorporated, Purchase, NY (US)

(72) Inventor: Simon Phillips, York (GB)

(21) Appl. No.: 15/827,205

(22) Filed: Nov. 30, 2017

(51) Int. Cl. G06Q 20/32; G06Q 20/12

(52) U.S. Cl. CPC G06Q 20/3276; G06Q 20/3278; G06Q 20/325; G06Q 20/12

(57) ABSTRACT

A screen display is displayed on a touchscreen display component of a computing device. The screen display includes an actuatable portion. The actuatable portion is for being triggered by a touch from a user to launch a payment process. Within the actuatable portion, a dynamic image is displayed. The dynamic image includes animated symbols that collectively represent a number of payment system brands.

### BACKGROUND

FIG. 1 is a block diagram that illustrates a conventional payment system 100.

The system 100 includes a conventional payment card/device 102. As is familiar to those who are skilled in the art, the payment card/device 102 may be a magnetic stripe card, an IC (integrated circuit) card, a fob, a payment-enabled smartphone, etc. The payment card/device 102 is shown being carried and used by an account holder/user 103.

The system 100 further includes a reader component 104 associated with a POS terminal 106. In some known manner (depending on the type of the payment card/device 102) the reader component 104 is capable of reading the payment account number and other information from the payment card/device 102.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction.

A computer 108 operated by an acquirer (acquiring financial institution) is also shown as part of the system 100 in FIG. 1. The acquirer computer 108 may operate in a conventional manner to receive an authorization request for the transaction from the POS terminal 106. The acquirer computer 108 may route the authorization request via a payment network 110 to the server computer 112 operated by the issuer of a payment account that is associated with the payment card/device 102. As is also well known, the authorization response generated by the payment card issuer server computer 112 may be routed back to the POS terminal 106 via the payment network 110 and the acquirer computer 108.

One well known example of a payment network is referred to as the “Banknet” system, and is operated by Mastercard International Incorporated, which is the assignee hereof.

The payment account issuer server computer 112 may be operated by or on behalf of a financial institution (“FI”) that issues payment accounts to individual users. For example, the payment account issuer server computer 112 may perform such functions as (a) receiving and responding to requests for authorization of payment account transactions to be charged to payment accounts issued by the FI; (b) tracking and storing transactions and maintaining account records; (c) rendering periodic account statements; and (d) receiving and tracking payments to the issuer from the account holders.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment cards or other devices for initiating payment transactions by presenting an associated payment account number to the reader component of a POS terminal.

Still further, and as is well-known, for e-commerce transactions, an e-commerce server computer (not shown in FIG. 1) may function as the POS terminal. The e-commerce server computer may be operated by or on behalf of a merchant and may be accessed by the account holder via a browser program running on (for example) a personal computer (not shown) or a tablet computer (not shown in FIG. 1). To arrange for the payment portion of the e-commerce transaction, the account holder may manually enter a payment account number, or authorize a charge from a payment account number held on file by the merchant, or access a digital wallet, etc.

The present inventor has previously proposed to launch a payment portion of an on-line transaction by scanning a displayed code with the camera component of a smartphone. The present inventor has now recognized an opportunity to optimize a checkout page downloaded from an e-commerce server to promote flexibility in payment, usability and attractiveness and informativeness from the point of view of the user.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and example embodiments and which are not necessarily drawn to scale, wherein:

FIG. 1 is a block diagram that illustrates a conventional payment system.

FIG. 2 is a block diagram that illustrates an embodiment of a payment system provided according to aspects of the present disclosure.

FIG. 3 is a block diagram that illustrates other aspects of the payment system of FIG. 2.

FIG. 4 is a schematic/partial block diagram of an embodiment of a tablet computer that may play a role in the payment system of FIGS. 2 and 3.

FIG. 5 is a block diagram that illustrates a computer system that may be a component of the payment system of FIGS. 2 and 3.

FIG. 6 is a simplified block diagram illustration of a smartphone that may be used in the payment system of FIGS. 2 and 3.

FIG. 7 is a flow chart that illustrates a process that may be performed according to aspects of the present disclosure in the payment system of FIGS. 2 and 3.

FIGS. 8 and 9 show example screen displays that may be provided in the payment system of FIGS. 2 and 3 in accordance with aspects of the present disclosure.

FIG. 10 is a flow chart that illustrates another process that may be performed according to aspects of the present disclosure in the payment system of FIGS. 2 and 3.

### DESCRIPTION

In general, and for the purpose of introducing concepts of embodiments of the present disclosure, a check-out page downloaded from an e-commerce server supports actuation of respective payment processes by touching a virtual button on the page or by scanning the button with a smartphone. The former manner of actuating payment may facilitate a payment process performed by a tablet computer that displays the page including the virtual button. The latter manner of actuating payment may facilitate a payment process triggered by a smartphone used to scan the virtual button. To enhance attractiveness and informativeness of the virtual button, it may include at least some degree of animation in which payment system brand names and/or logos are presented in a cyclical or quasi-cyclical manner to indicate to the user that payment options are available via interaction with the virtual button.

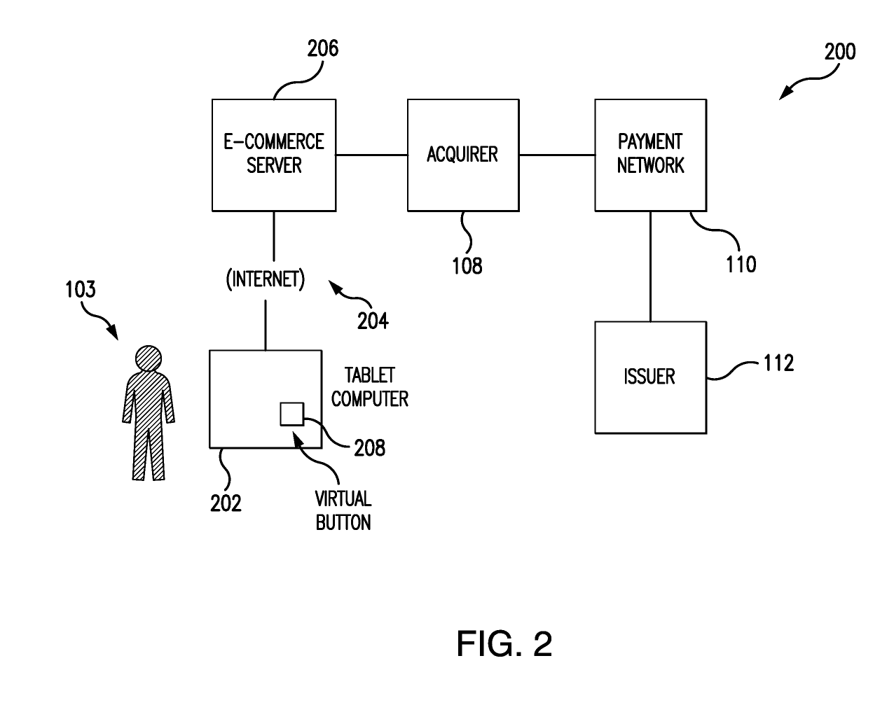

FIG. 2 is a block diagram that illustrates an embodiment of a payment system 200 provided according to aspects of the present disclosure.

FIG. 2 shows a user 103 operating a tablet computer 202 which may, in some circumstances, perform payment functions in connection with the payment system 200. The tablet computer 202 is shown engaging in data communications via the internet 204 with a merchant e-commerce server 206. During the interaction, the tablet computer displays webpage screen displays downloaded to the tablet computer 202 from the merchant e-commerce server 206. Included in at least one of the displayed webpage screen displays is a virtual button 208, which is mentioned above and is described in greater detail at a later section of this disclosure.

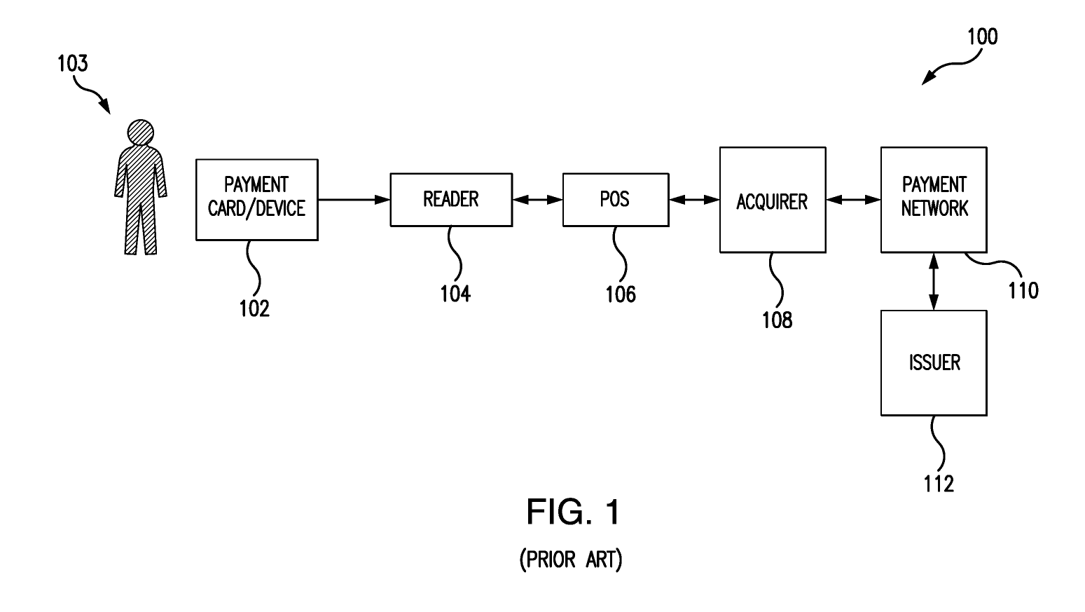

The system 200 may further include the acquirer computer 108 (in communication with the merchant e-commerce server 206), payment network 110 and issuer computer 112, as referred to above in connection with FIG. 1. The latter three elements may provide essentially the same functionality as in the conventional payment system 100 described above in connection with FIG. 1.

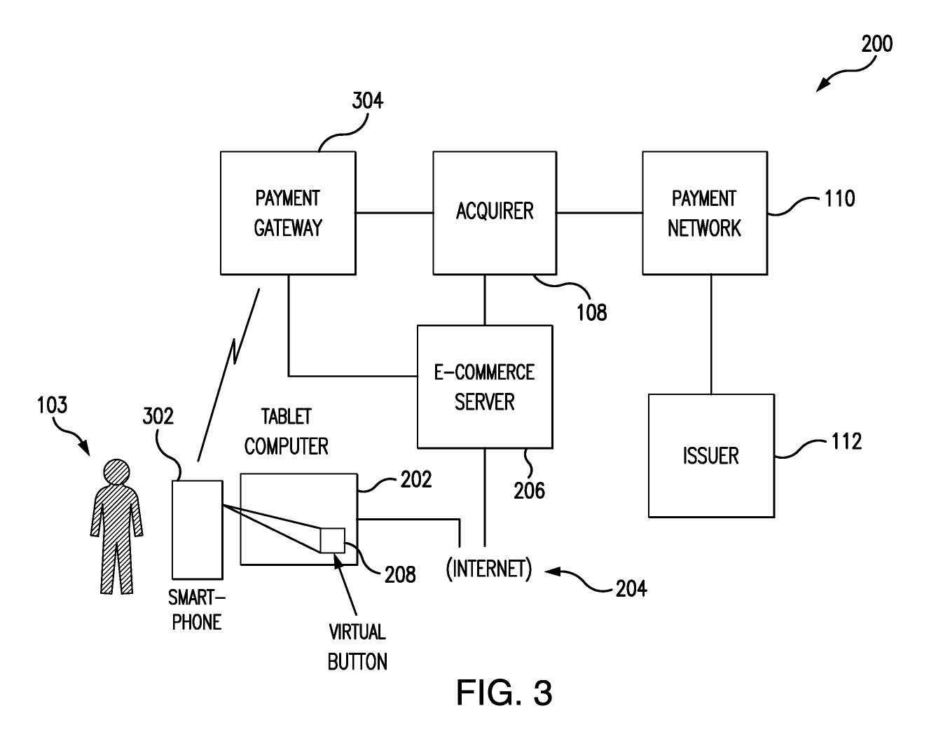

FIG. 3 is a block diagram that illustrates other aspects of the payment system 200.

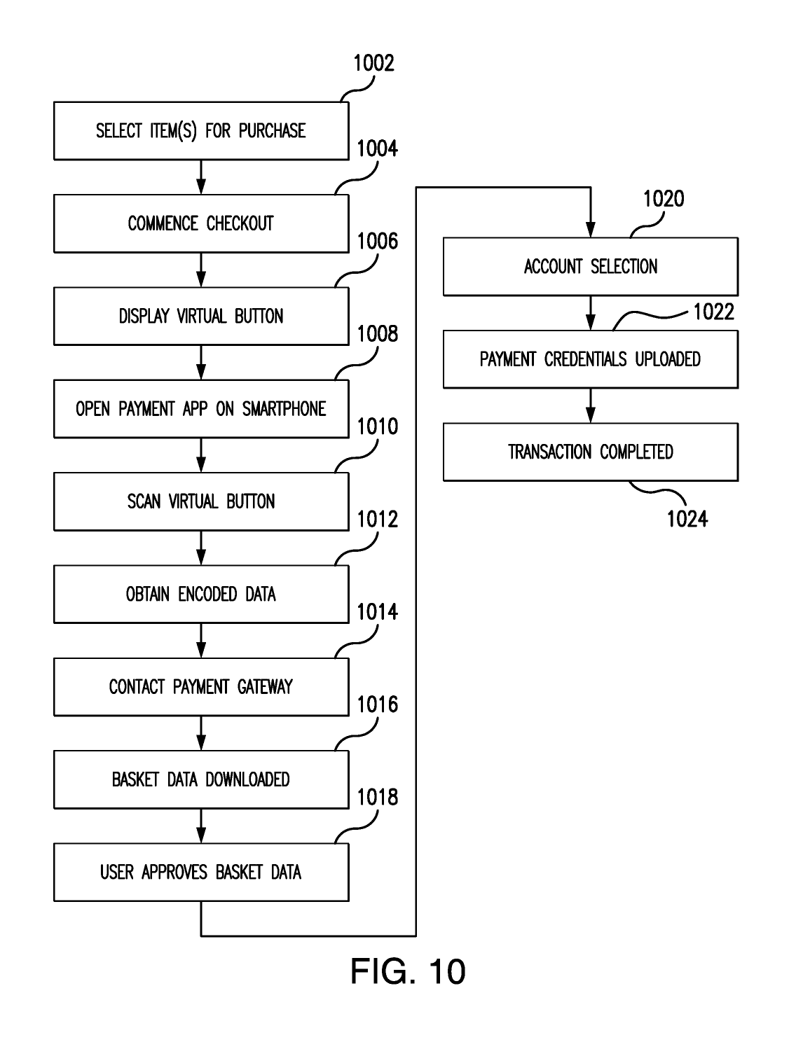

FIG. 3 shows all the elements that were depicted in FIG. 2. In addition, FIG. 3 shows the user 103 operating a smartphone 302 to scan the above-mentioned virtual button 208 displayed by the tablet computer 202. The scan of the virtual button 208 by the smartphone 302 enables the smartphone to obtain data that points to a data entry of shopping basket data stored in a payment gateway computer 304. The payment gateway computer 304 is in communication with the merchant e-commerce server 206 to receive the shopping basket data for a current online shopping transaction that the user 103 is pursuing via the tablet computer 202. The shopping basket data is downloaded from the payment gateway computer 304 to the smartphone 302 in response to a process triggered by the scanning of the virtual button 208. Details of the process are described below, particularly with reference to FIG. 10.

Both the illustrations in FIGS. 2 and 3 only show system components required for a single transaction. As noted in connection with FIG. 1, in practical embodiments of the system 200, there may be a considerable number of acquirers and issuers, as well as numerous merchants and many users operating tablet computers, smartphones and other devices (such as payment cards). Moreover, other functionality provided by system 200 may accommodate conventional POS and/or online shopping transactions. There also may be more than one payment gateway computer.

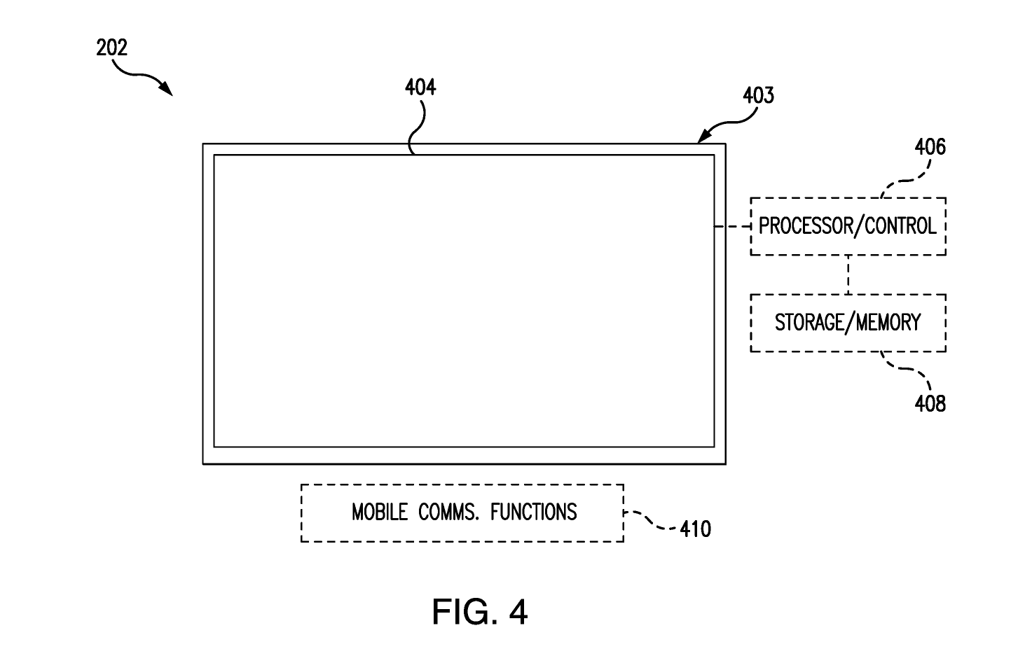

FIG. 4 is a schematic/partial block diagram of an embodiment of the tablet computer 202. In some embodiments, the tablet computer 202 may be entirely conventional in terms of its hardware aspects, and may run a conventional mobile browser. Via the mobile browser the tablet computer 202 may interact with the merchant e-commerce server 206. As a result, one or more webpages may be downloaded to the tablet computer 202 from the merchant e-commerce server 206 to enable the tablet computer 202 to display a novel screen display feature as described herein.

The tablet computer 202 may include a housing 403. The front of the housing 403 may be predominantly constituted by a touchscreen 404, which plays a central role in the user interface provided by the tablet computer 202.

The tablet computer 202 may further include a mobile processor/control 406 and a storage/memory device 408. For convenience of illustration the blocks 406 and 408 are shown outside of the housing 403, but the dot-dash representation of those blocks is intended to convey that the corresponding components are contained in/supported by the housing 403. The mobile processor/control 406 is in communication with the storage/memory device 408 and the touchscreen 404. The storage/memory device 408 may store program instructions (including mobile applications or “apps”) to control the mobile processor/control 406 to manage and carry out the functionality provided by the tablet computer 202.

As is the case for many tablet computers, the tablet computer 202 may include mobile communications functions as represented by block 410. The mobile communications functions may include voice and data communications via a mobile communication network (not shown) with which the tablet computer 202 is registered. Block 410 is represented in dot-dash form to again indicate that the physical components providing the mobile communication functions are contained in and/or supported by the housing 403 of the tablet computer 202.

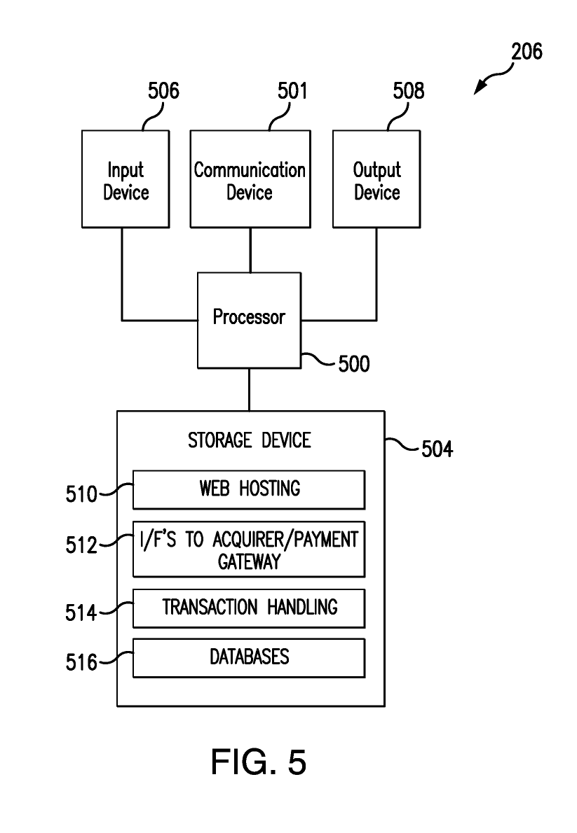

FIG. 5 is a block diagram that illustrates an example embodiment of the merchant e-commerce server 206 shown in FIGS. 2 and 3.

Referring now to FIG. 5, the merchant e-commerce server 206 may, in its hardware aspects, resemble a typical server computer, but may be controlled by software to cause it to function as described herein.

The merchant e-commerce server 206 may include a computer processor 500 operatively coupled to a communication device 501, a storage device 504, an input device 506 and an output device 508. The communications device 501, the storage device 504, the input device 506 and the output device 508 may all be in communication with the processor 500.

The computer processor 500 may be constituted by one or more processors. Processor 500 operates to execute processor-executable steps, contained in program instructions described below, so as to control the merchant e-commerce server 206 to provide desired functionality.

Communication device 501 may be used to facilitate communication with, for example, other devices (such as customers' tablet computers and other computing devices operated by customers). Communication device 501 may comprise numerous communication ports (not separately shown), to allow the merchant e-commerce server 206 to communicate simultaneously with a number of other devices, including communications as required to simultaneously handle numerous interactions with other devices.

Input device 506 may comprise one or more of any type of peripheral device typically used to input data into a computer. For example, the input device 506 may include a keyboard and a mouse. Output device 508 may comprise, for example, a display and/or a printer.

Storage device 504 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 504 stores one or more programs for controlling processor 500. The programs comprise program instructions (which may be referred to as computer readable program code means) that contain processor-executable process steps of the merchant e-commerce server 206, executed by the processor 500 to cause the merchant e-commerce server 206 to function as described herein.

The programs may include one or more conventional operating systems (not shown) that control the processor 500 so as to manage and coordinate activities and sharing of resources in the merchant e-commerce server 206, and to serve as a host for application programs (described below) that run on the merchant e-commerce server 206.

The programs stored in the storage device 504 may include, for example, a website hosting application program 510. The website hosting application program 510 may control the processor 500 so as to enable the merchant e-commerce server 206 to make an e-commerce website available for online shopping transactions by customers who visit the website.

In addition, the storage device 504 may store a software interface 512 that facilitates communication between the merchant e-commerce server 206 and either or both of a transaction acquirer (block 108, FIGS. 2 and 3) and a payment gateway computer (block 304, FIG. 3).

Still further, the storage device 504 may store a transaction handling application program 514. The transaction handling application program 514 may control the processor 500 so as to enable the merchant e-commerce server 206 to engage in transaction handling pursuant to requests from customers' devices (e.g., the tablet computer 202, FIGS. 2 and 3) and in accordance with aspects of the present disclosure. Details of the operation of the merchant e-commerce server 206 pursuant to the transaction handling application program 514 will be described below.

The storage device 504 may also store, and the merchant e-commerce server 206 may also execute, other programs, which are not shown. For example, such programs may include a reporting application, which may respond to requests from system administrators for reports on the activities performed by the merchant e-commerce server 206. The other programs may also include, e.g., device drivers, database management programs, communications software, etc.

The storage device 504 may also store one or more databases (reference numeral 516) required for operation of the merchant e-commerce server 206.

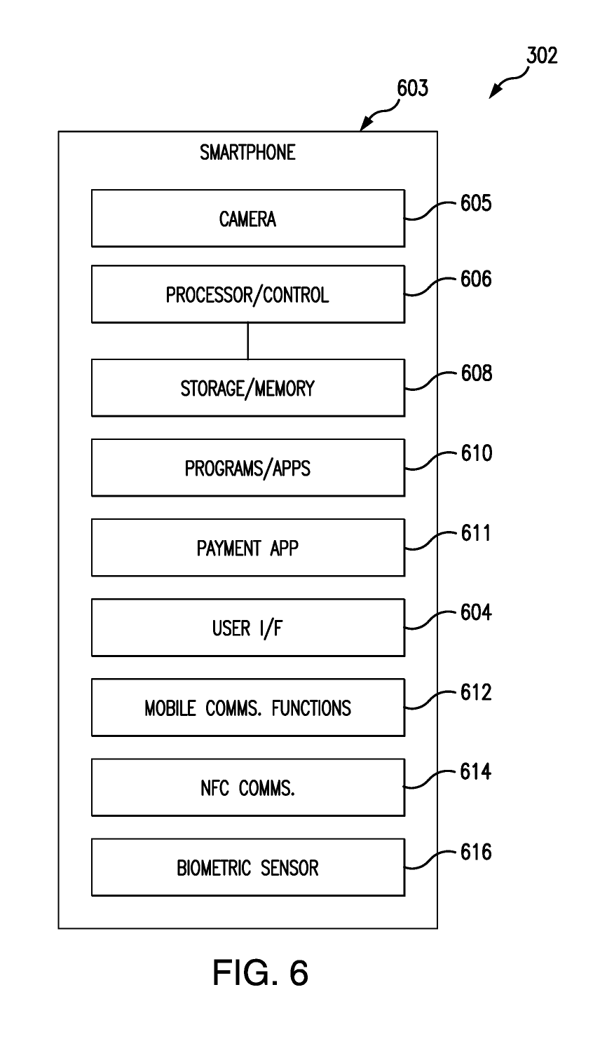

FIG. 6 is a simplified block diagram illustration of an embodiment of the smartphone 302 shown in FIG. 3.

The smartphone 302 may include a housing 603. In many embodiments, the front of the housing 603 is predominantly constituted by a touchscreen (not separately shown), which is a key element of the user interface 604 of the smartphone 302.

Further, as is quite typical of smartphones or other mobile devices, the smartphone 302 includes a digital camera component (block 605) contained in/supported on the housing 603. The digital camera component 605, as is also now typical, may include functionality that captures and stores digital moving images.

The smartphone 302 further includes a mobile processor/control circuit 606, which is contained within the housing 603. Also included in the smartphone 302 is a storage/memory device or devices (reference numeral 608). The storage/memory devices 608 are in communication with the processor/control circuit 606 and may contain program instructions to control the processor/control circuit 606 to manage and perform various functions of the smartphone 302. The processor 606 may be in communication with the digital camera component 605. As is well-known, the smartphone 302 may function as what is in effect a pocket-sized personal computer, via programming with a number of application programs, or “apps”, as well as a mobile operating system (OS). (The apps are represented at block 610 in FIG. 6, and may, along with other programs, in practice be stored in block 608, to program the processor/control circuit 606.)

Also shown in FIG. 6 is a payment app 611. The payment app 611 is shown apart from the other apps represented at block 610, in part due to the particular relevance of the payment app 611 to the subject of this disclosure. In addition, the separate representation of the payment app 611 also may be considered to represent the possibility that it is stored in a secure element (SE—not shown apart from block 611 or block 608), which may be provided in some embodiments of the smartphone 302 to provide enhanced security for the payment app 611 and/or sensitive data associated therewith. The SE, if present, may be conventional in its hardware aspects. In addition or alternatively, security for the payment app 611 may be enhanced by alternatives to an SE known to those skilled in the art, such as a TEE (trusted execution environment).

To the extent that the SE includes processing capabilities, it may functionally (though likely not physically) overlap with block 606; to the extent that the SE includes storage (and particularly program storage) capabilities, it may functionally (though likely not physically) overlap with block 608.

In some embodiments, the payment app 611 may in many respects resemble a conventional payment app that permits the smartphone 302 to engage in contactless payment transactions at a point of sale. In addition, however, the payment app 611 may be programmed to provide functionality as described herein.

As is typical, the smartphone 302 may include mobile communications functions as represented by block 612. The mobile communications functions may include voice and data communications via a mobile communication network (not shown) with which the smartphone 302 is registered.

In addition, to facilitate use as a payment-enabled device at a point of sale, the smartphone 302 may include short-range radio communications capabilities (block 614), including for example NFC (near field communication). Thus block 614 may represent a suitable antenna (not separately shown) that is appropriate for NFC communications as well as driving and receiving circuitry associated with the antenna. It will be appreciated that the NFC antenna may be separate and different from the antenna (not separately shown) utilized by the smartphone 302 for the mobile communication functions represented by block 612.

Also shown in FIG. 6 is a biometric sensor 616, which may be one of the components of the smartphone 302. The biometric sensor 616 may be, for example, a fingerprint sensor, and may operate to assist in authenticating the user of the smartphone 302 in connection with payment transactions.

From the foregoing discussion, it will be appreciated that the blocks depicted in FIG. 6 as components of the smartphone 302 may in effect overlap with each other, and/or there may be functional connections among the blocks which are not explicitly shown in the drawing. It may also be assumed that, as is typical, the smartphone 302 may include a rechargeable battery (not shown) that is contained within the housing 603 and that provides electrical power to the active components of the smartphone 302.

While smartphone 302 is shown in FIG. 3 as the device used to scan the virtual button 208 displayed by the tablet computer 202, in other embodiments a mobile device other than a smartphone may be suitably programmed with a payment app and may be used to provide the functionality ascribed herein to the smartphone 302.

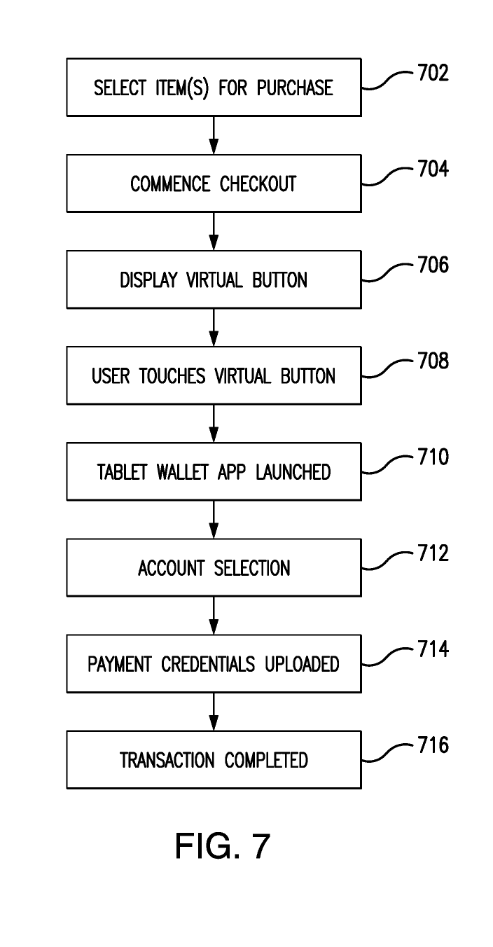

FIG. 7 is a flow chart that illustrates a process that may be performed according to aspects of the present disclosure in the payment system 200. The process of FIG. 7 may be considered pertinent to the aspects of the payment system 200 as it is depicted in FIG. 2. It is assumed for the purpose of FIG. 7 that the user 103 has operated the tablet computer 202 to access the online store hosted by the merchant e-commerce server 206.

At 702, the user 103 selects one or more items to be purchased by interacting with the above-mentioned online shopping website to view products and to designate one or more products for inclusion in a virtual shopping cart or basket.

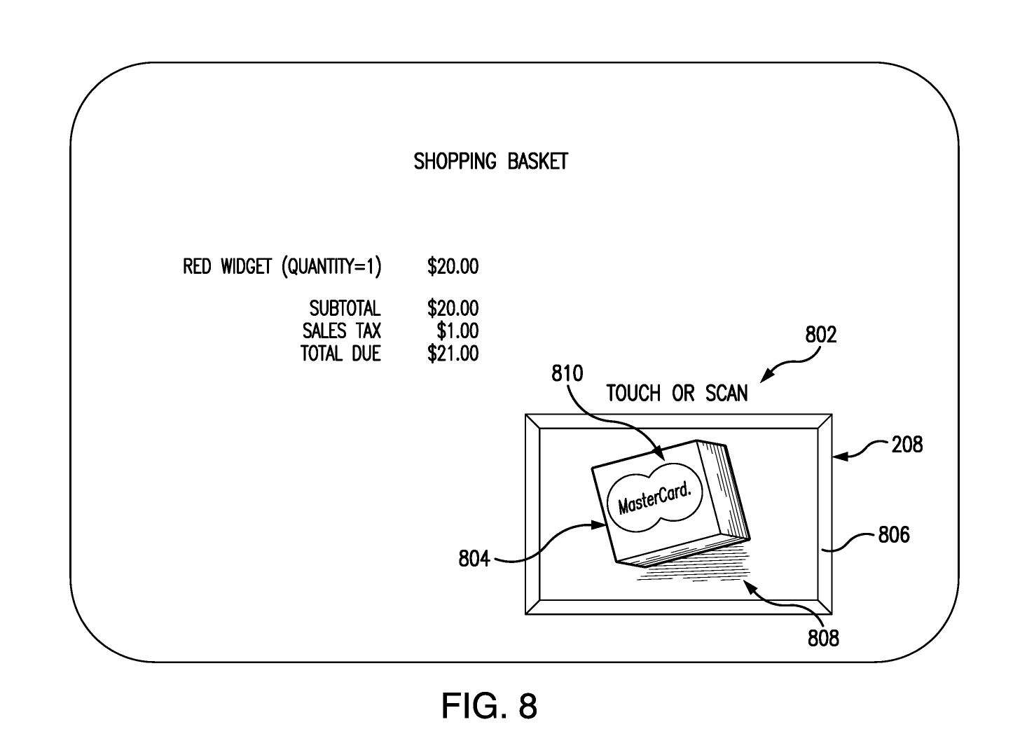

At 704, the user 103 commences the checkout process. To do so, the user may merely actuate a virtual button (different from the virtual button 208 referred to above) on a shopping webpage downloaded to the tablet computer 202 to indicate that the user 103 has selected all items desired at the present time and is ready to proceed to checkout. The merchant e-commerce server 206 may then respond by entering the checkout phase of the online shopping transaction. As part of doing so, the merchant e-commerce server 206 may download to the tablet computer 202 a “shopping basket” screen display, such as that shown in FIG. 8. FIG. 8 shows the downloaded screen display as displayed on the touchscreen (not separately shown in FIG. 8) of the tablet computer 202 (not separately shown in FIG. 8). As seen from FIG. 8, the displayed shopping basket screen display includes the virtual button 208 that was discussed in connection with FIGS. 2 and 3. (Thus, the tablet computer 202 displays the virtual button 208, as indicated at block 706 in FIG. 7.) The virtual button 208, as shown in FIG. 8, is adjacent a text block 802. The text block 802 may include instructions such as “TOUCH OR SCAN.”

The virtual button 208 may be a touch-actuatable portion of the screen display of FIG. 8, such that—when touched by the user—a payment or wallet app (if present) in the tablet computer 202 is launched and brought into the checkout process.

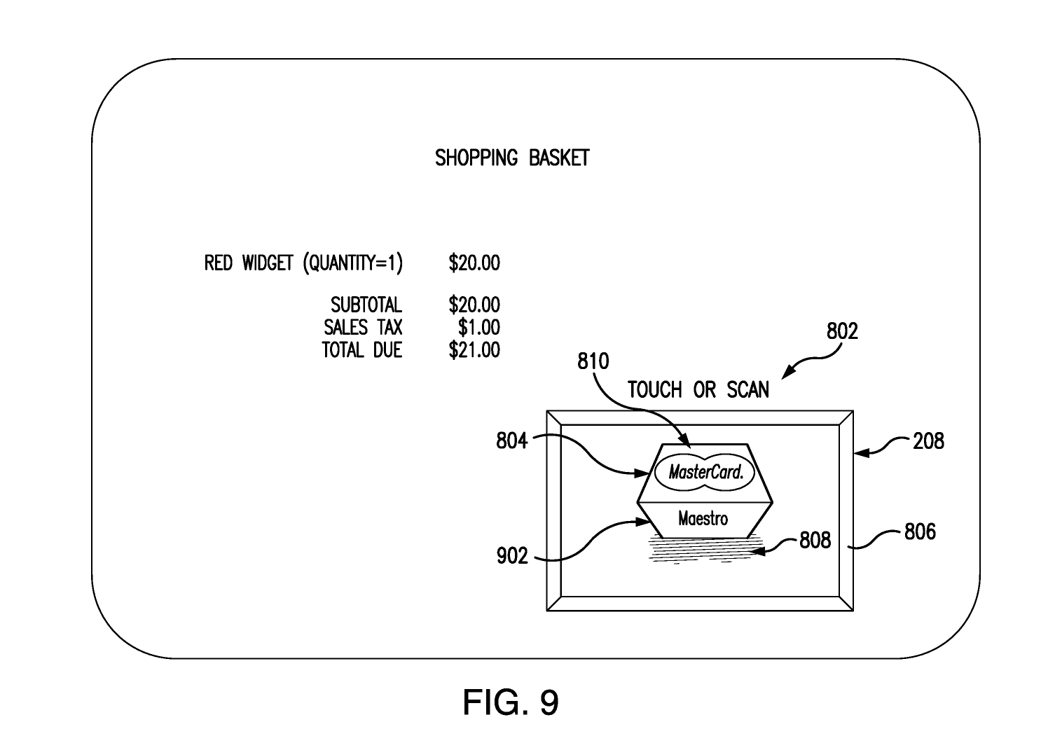

In one embodiment of the virtual button 208 (which, as noted above is a component of the shopping basket webpage/screen display as downloaded from the merchant e-commerce server 206), an animated/dynamic “cube” visual element 804 (hereinafter, the “dynamic cube”) is featured within/as part of the virtual button 208. The dynamic cube may spin, wobble, appear to increase or decrease in size (i.e., appear to move closer to or further away from the viewer) and/or change position within the outline 806 of the virtual button 208. Simulated shading and lighting effects and so forth may be applied to the dynamic cube 804 and/or its faces. The motion of the animated cube can be appreciated by comparing FIG. 9 with FIG. 8. FIG. 9 shows the screen display of FIG. 8 and the virtual button 208 at a slightly later point in time than in FIG. 8.

In one effect that can be clearly seen in FIGS. 8 and 9, a shadow 808 is presented as being cast by the dynamic cube 804. As the dynamic cube 804 moves, changes size, etc., the shadow 808 may also move, and change size and shape within the screen display and within the virtual button 208, to enhance the simulation of realism that enhances the appearance and attractiveness of the dynamic cube 804.

A number of faces of the dynamic cube 804 may each display the brand/logo of a respective payment account network. For example, one face, as indicated at 810, may “wear” the famous logo of Mastercard International Incorporated, which is the assignee hereof. Other faces of the dynamic cube 810, (which are not visible in FIG. 8), may respectively bear the logos of other payment networks, such as, for example, Visa®, Discover®, American Express®, etc. Referring to FIG. 9, a second face 902 of the dynamic cube 804 is visible within the virtual button 208. The face 902 is shown as displaying the payment system brand name “Maestro.” As the dynamic cube 804 is, in appearance, turned and rotated (through perhaps two degrees of freedom), each other cube face may cyclically become visible to show several other payment system brands/logos. Thus, the dynamic cube represents a collection of animated symbols that together represent a plural number of payment system brands. Though each brand may be visible in cyclical fashion over time, it is not intended to limit the cyclicality of the brand presentation to a regular cycle. For example, one brand may be made visible two or three times in between occasions when another one of the brands is visible.

The dynamic cube 804, as shown and described herein, is only one example of numerous types of brand animation presentations that may be provided in accordance with teachings of this disclosure. It will be appreciated that an animation such as the dynamic cube 804 may accommodate six different payment system brands. If a smaller or larger number of payment system brands is desired to be displayed, then the merchant e-commerce server 206 may be programmed such that an animated polygon with more or fewer than six faces (but otherwise possibly similar to dynamic cube 804) may be displayed within the virtual button 208. It will be appreciated that such a polygon may have a different payment system brand presented on each of its faces. If a polygon is employed to present a collection of animated brand symbols, the polygon need not be a regular polygon. As an alternative to a polygon, an animated sphere or other smooth-surfaced animated geometrical figure may be dressed virtually with brand symbols, with each symbol occupying a respective location on the sphere or other figure. As with the animated cube 804, an animated smooth-surfaced, brand-displaying figure may spin, wobble, decrease or increase in size and/or change position within the virtual button 208, with or without shading, lighting and/or shadow-casting effects as previously described in connection with the description of the animated cube 804.

Other types of collections of animated brand symbols may alternatively be displayed within the virtual button 208. Free form presentations may be used, for example, with brand symbols/names successively (though not necessarily regularly) coming into view, apparently passing through space (in any horizontal, vertical, diagonal or other direction) and disappearing. Two or more of such symbols/names may be visible (at least partially) at the same time or times with such a free form presentation.

Another possible animation may resemble a slot machine display in appearance, with brand names/symbols rotating into and out of view as if on slot machine wheels. A rapidly updated traffic light animation may alternatively be used to present the brand names/symbols in lieu of the conventional red, amber and green lights customarily seen in a traffic signal. In the latter type of animation, any one of three or more brand names/symbols may appear in any position in the traffic light display.

There are many other ways in which payment system brands/logos may be presented in animated fashion within the virtual button 208 displayed on the touchscreen 404 (FIG. 4) of the tablet computer 202 as part of a screen display page downloaded to the tablet computer 202 from the merchant e-commerce server 206. Any or all of such presentations of the payment system brands/logos may be considered to be within the contemplation of this disclosure.

Other capabilities of the virtual button 208, relating to provision of scannable data, will be described below in conjunction with FIG. 10.

Referring again to FIG. 7, block 708 may follow block 706 in the process illustrated in FIG. 7. At block 708, and as suggested above, the user 103 may touch the virtual button 208 displayed on the tablet computer 202 to launch a payment capability programmed into the tablet computer 202 (e.g., such as a wallet or payment app). In response to the user 103 touching the virtual button 208, the tablet computer wallet/payment app is launched/opened, as indicated at block 710 in FIG. 7.

Block 712 may follow block 710 in the process illustrated in FIG. 7. At block 712—assuming that data representing more than one payment account has been provisioned to the user's wallet—the user may proceed to select among the payment accounts included in the wallet to designate the payment account to be used (charged) for the current transaction.

Block 714 may follow block 712. At block 714 the wallet app may upload the payment credentials corresponding to the designated payment account to the merchant e-commerce server 206 or may cause the payment credentials to be transmitted to the merchant e-commerce server 206 (e.g., from a remote server, which is not shown). As will be understood by those who are skilled in the art, the payment credentials may include a payment account number or a token that points to the user's payment account, as well as related information.

The payment account transaction (online shopping transaction) may then be completed in a conventional manner, as indicated by block 716 in FIG. 7.

FIG. 10 is a flow chart that illustrates another process that may be performed according to aspects of the present disclosure in the payment system 200. The process of FIG. 10 may be considered pertinent to the aspects of the payment system 200 as it is depicted in FIG. 3. The user 103 may elect to pursue the process of FIG. 10 in the event that the tablet computer 202 lacks payment capability, such as a payment or wallet app, or if such capability is there but the user 103 prefers to utilize payment capabilities of the smartphone 302 to facilitate the transaction. It is assumed for the purpose of FIG. 10 that the user 103 has operated the tablet computer 202 to access the online store hosted by the merchant e-commerce server 206.

At 1002, the user 103 selects one or more items to be purchased by interacting with the above-mentioned online shopping website to view products and to designate one or more products for inclusion in a virtual shopping cart or basket.

At 1004, the user 103 commences the checkout process. To do so, the user may merely actuate a virtual button (different from the virtual button 208 referred to above) on a shopping webpage downloaded to the tablet computer 202 to indicate that the user 103 has selected all items desired at the present time and is ready to proceed to checkout. The merchant e-commerce server 206 may then respond by entering the checkout phase of the online shopping transaction. As part of doing so, the merchant e-commerce server 206 may download to the tablet computer 202 a “shopping basket” screen display, such as that shown in FIG. 8. FIG. 8 shows the downloaded screen display as displayed on the touchscreen (not separately shown in FIG. 8) of the tablet computer 202 (not separately shown in FIG. 8). As seen from FIG. 8, the displayed shopping basket screen display includes the virtual button 208 that was discussed in connection with FIGS. 2 and 3. (Thus the tablet computer 202 displays the virtual button 208, as indicated at block 1006 in FIG. 10.)

At 1008, the user 103 may operate the smartphone 302 (FIG. 3) to open the payment application 611 (FIG. 6). In some embodiments, the opening of the payment application 611 may be accomplished by the user 103 presenting his/her fingertip to a fingerprint scanner (biometric sensor 616, FIG. 6), such that user authentication along with opening of the payment application 611 are accomplished with a single action. Alternatively, the payment application may be opened by selecting a virtual button (not virtual button 208) suitably displayed on the smartphone 302. User interface and user authentication may then proceed biometrically and/or by PIN entry and verification, etc.

Continuing to refer to FIG. 10, at block 1010, the user 103 may operate the smartphone 302 to scan the virtual button 208 to launch the next stage of the payment process. The user 103 may do so in response to the text block 802 shown in FIG. 8 as being displayed by the tablet computer 202. In the scanning process step, the camera component 605 (FIG. 6) of the smartphone 302 may be positioned relative to the virtual button 208 so that the camera component 605 may capture a sequence of images displayed within the virtual button 208. The scanning of the virtual button 208 may involve obtaining moving images displayed within the virtual button 208 to capture the modulation over time of at least some portions of the virtual button 208. Alternatively, the scanning of the virtual button 208 may involve capturing one or more static display elements displayed within the virtual button 208.

Functionality of the virtual button 208 to present scannable data will now be described.

One or more features displayed within the virtual button 208 may be modulated over time to encode certain data to facilitate completion of the purchase transaction. Because the data-bearing feature or features are modulated over time, the feature or features vary over time (though perhaps not in any manner that is perceptible to the human eye); accordingly the feature or features may be referred to as dynamic. As discussed above, the feature or features displayed within the virtual button 208 may also be dynamic in the sense that they exhibit animation features or the like that are visible/attractive to the user, with the visible dynamic effects not necessarily directly involved in presenting coded information.

The optically-scannable encoding associated with the virtual button 208 may be implemented in a number of different ways. Preferably, the encoding features involve modulation over time in a manner that is not visible or noticeable to the human eye, such that the aesthetic appearance of the virtual button 208 is not adversely affected. For example, in some embodiments, one or a number of selected locations within the virtual button 208 (perhaps only a few pixels in diameter/size) may be “pulsed” to represent encoded information, with the pulsing exhibited (subject to image analysis but preferably below the threshold of human optical perception) in terms of one or more changes in color, tone, brightness, position, speed and/or direction of movement, contrast, and/or intensity, etc. In addition or alternatively, the modulation may affect the shading/lighting effects applied to the currently visible faces of a dynamic cube or other polyhedron displayed within the virtual button 208.

In some embodiments, instead of modulating/encoding a dynamic feature displayed within the virtual button 208, an apparently static feature may be modulated in one or more of the manners described above to represent encoded information to be obtained by scanning the virtual button 208. In some embodiments, modulation of a displayed feature and encoding of information, may be accomplished by moving one or more portions of the feature or the entire feature or a shadow apparently cast by the feature relative to the frame (not shown) that is displayed within the virtual button 208 in some embodiments. If present, the frame may serve as a reference element for the image processing that is discussed below. In some embodiments, the borders of the virtual button 208 may serve as a frame.

In other embodiments, a more or less conventional coded element, such as a QR (quick response) code (i.e., a barcode) may be included in the virtual button and/or other static coded features may be presented, such as one or more straight or non-straight dash-dot lines with encoding within a line-wise-variable dash-dot sequence in the encoded line. Referring again to FIG. 10, at 1012, the smartphone 302, (e.g., via the payment application 611), may analyze the moving images (or a still image) captured at 1010 to detect the encoded information presented within the virtual button 208. The encoded information may include, for example, an address (e.g. a web address) for the payment gateway computer 304 (FIG. 3). (Alternatively, the payment gateway computer 304 may not be present or involved, and the encoded information may provide a web address for the merchant e-commerce server 206.) The encoded information may also include a “basket number” that points to transaction data for the current transaction that has been stored in the payment gateway computer 304. In some embodiments, as an alternative or supplement to the basket number, the virtual button 208 may also present, and the payment application 611 may also detect, transaction data, such as total transaction amount, merchant identifier, etc.

Still referring to FIG. 10, at 1014, the smartphone 302 (under control by the payment application 611) may use the payment gateway address information to contact the payment gateway computer 304 so as to establish a channel of communication with the payment gateway computer 304. Once the channel of communication is established, the smartphone 302/payment application 611 may transmit the basket number to the payment gateway computer 304.

At 1016 in FIG. 6, the payment gateway computer 304 may use the basket number to retrieve the relevant transaction data, and then may download the transaction data to the smartphone 302. At 1018, the smartphone 302/payment application 611 may display the transaction data and prompt the user 103 to indicate whether he or she approves the transaction. The user 103 may indicate approval by suitable interaction with the mobile device user interface. (In some embodiments, the user authentication—e.g., biometrically—may occur at this stage rather than in conjunction with opening the payment app, as referred to above in connection with step 1008.)

Block 1020 may follow block 1018 in the process illustrated in FIG. 10. At block 1020—assuming that data representing more than one payment account has been provisioned to the user's wallet accessible via, or stored in, the smartphone 302—the user may proceed to select among the payment accounts included in the wallet to designate the payment account to be used (charged) for the current transaction.

Block 1022 may follow block 1020. At block 1020, the smartphone 302 may transmit the payment credentials corresponding to the designated payment account to the payment gateway computer 304 or may cause the payment credentials to be transmitted to the payment gateway computer 304 (e.g., from a remote server which is not shown). As will be understood by those who are skilled in the art, the payment credentials may include a payment account number or a token that points to the user's payment account, as well as related information.

The payment account transaction (online shopping transaction) may then be completed via the payment gateway computer 304, as indicated by block 1024 in FIG. 10. For example, the payment gateway computer 304 may generate and transmit to the acquirer 108 a suitable transaction authorization request message, and other suitable processing of a payment account system transaction may ensue as is known to one skilled in the art. With a virtual button 208, as described above, downloaded to and displayed on the user's tablet computer 202, the user 103 may be enabled to conveniently access payment capabilities of the tablet computer 202 or the smartphone 302. The virtual button 208 may also present an aesthetically pleasing payment prompt and opportunity to select a payment option to the user 103.

In terms of presentation of encoded data via the virtual button 208, it is within the contemplation of this disclosure that encoding techniques like those described above or other encoding techniques may be employed. Among the encoding techniques that may be employed is steganography in the spatial and/or frequency domain or adaptive steganography (which operates in both the spatial and frequency domains). Watermarking is another encoding technique that may be employed. The watermarking may use an LSB (least significant bit) method or a thresholding approach, or may be carried out in the frequency domain using transforms such as the Fast Fourier Transform (FFT) or the Discrete Cosine Transform (DCT).

Machine vision techniques may also be employed to recognize encoded features of the virtual button 208. One or more machine vision techniques such as color or “blob” detection, feature or shape detection, template matching and motion detection may be employed. Furthermore, pattern recognition techniques may also be used for the same purpose. Still another technique that may be used is motion tracking to recognize hidden moving features that bear the encoded data within the virtual button 208. Still another technique that may be employed is color change tracking.

It is further contemplated that animation recognition may be employed, such that animation featured within the virtual button 208 is uniquely generated (but not perceptibly differently generated) for each user. For detection purposes, a hash may be calculated over the captured animation to identify the user and launch the transaction.

In embodiments described above, information obtained by the smartphone 302 by scanning the virtual button 208 was encoded information represented by modulation of a dynamic or (apparently) static image feature. Alternatively, however, and in addition to obtaining some information from encoded-by-modulation detected data, the smartphone 302/payment application 611 may also obtain information from other aspects of the image (s) displayed within the virtual button 208. For example, the mobile device may perform optical character recognition (OCR processing) on portions of the virtual button 208 to obtain information (e.g., transaction information) therefrom.

Although embodiments referred to above have been described in the context of a payment card account system in which credit card account transactions, debit card account transactions and other typical payment card account system transactions are performed, the teachings of this disclosure are not limited to such transactions. In other embodiments, the teachings of the present disclosure may also be applied to payment transactions that utilize an ACH (automated clearing house) system and/or to transfers of value that utilize blockchain technology.

The above descriptions and illustrations of processes herein should not be considered to imply a fixed order for performing the process steps. Rather, the process steps may be performed in any order that is practicable, including simultaneous performance of at least some steps and/or omitting at least one step.

Although the present invention has been described in connection with specific example embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
displaying a screen display on a touchscreen display component of a computing device, the screen display including an actuatable portion, the actuatable portion for being triggered by a touch from a user to launch a payment process; and
displaying, within the actuatable portion, a dynamic image, the dynamic image including animated symbols that collectively represent a plurality of payment system brands.

2. The method of claim 1, wherein:
the payment process is a first payment process; and
the dynamic image includes at least one feature, the at least one feature presenting data in a scannable form;
the method further comprising:
scanning said data for launching a second payment process different from the first payment process.

3. The method of claim 2, wherein:
said computing device is a first mobile device; and
said scanning is performed with a digital camera that is included in a second mobile device different from the first mobile device.

4. The method of claim 3, wherein:
the first mobile device is a tablet computer; and
the second mobile device is a smartphone.

5. The method of claim 2, wherein the feature is animated and encodes the data by pulsing at least one selected location on the feature.

6. The method of claim 1, wherein the dynamic image includes an animated polyhedron that incorporates said animated symbols.

7. The method of claim 6, wherein the animated polyhedron is an animated cube.

8. The method of claim 1, wherein a barcode is displayed within the actuatable portion of the screen display.

9. The method of claim 8, wherein the barcode is a QR (quick response) code.

10. The method of claim 1, wherein said displaying occurs during a check-out phase of an online shopping transaction performed by the user via the computing device.

11. A method comprising:
initiating an online shopping transaction on a computing device that includes a touchscreen, said computing device being a first device; and
displaying a screen display on the touchscreen, the screen display including a virtual button, the virtual button for enabling (a) a first payment process option to a user of the computing device, and (b) a second payment process option to the user of the computing device;
the first payment process option selectable by the user touching the virtual button;
the second payment process option selectable by scanning the virtual button, said scanning performed by a second device different from the first device;
the virtual button displaying a dynamic image, the dynamic image including animated symbols that collectively represent a plurality of payment system brands.

12. The method of claim 11, wherein the first payment option is executable via a payment application that runs on the first device.

13. The method of claim 11, wherein the second payment option is executable via a payment application that runs on the second device.

14. The method of claim 13, wherein the second device is a smartphone.

15. The method of claim 11, wherein the first device is a tablet computer.

16. The method of claim 11, wherein the dynamic image includes an animated polyhedron that incorporates said animated symbols.

17. The method of claim 16, wherein the animated polyhedron is an animated cube.

18. A computing device comprising:
a processor;
a memory in communication with the processor; and
a touchscreen in communication with the processor;
the memory storing program instructions; the processor operative with the program instructions to perform functions as follows:
displaying a screen display on the touchscreen, the screen display including an actuatable portion, the actuatable portion for being triggered by a touch from a user to launch a payment process; and
displaying, within the actuatable portion, a dynamic image, the dynamic image including animated symbols that collectively represent a plurality of payment system brands.

19. The computing device of claim 18, wherein:
the dynamic image includes at least one feature, the at least one feature presenting data in a scannable form; and
the feature is animated and encodes the data by pulsing at least one selected location on the feature.

20. The computing device of claim 19, wherein the dynamic image includes an animated polyhedron that incorporates said animated symbols.
